(19) United States
(12) Patent Application Publication
(10) Pub. No.: US 2025/0208798 A1
(43) Pub. Date: Jun. 26, 2025

(54) PRINTING SYSTEM, PRINTING APPARATUS, AND MEDIUM STORING PRINTING PROGRAM

(71) Applicant: BROTHER KOGYO KABUSHIKI KAISHA, Nagoya (JP)

(72) Inventor: Shuhei SUZUKI, Nagoya (JP)

(73) Assignee: BROTHER KOGYO KABUSHIKI KAISHA, Nagoya (JP)

(21) Appl. No.: 18/990,405

(22) Filed: Dec. 20, 2024

(30) Foreign Application Priority Data
Dec. 26, 2023 (JP) 2023-219467

(51) Int. Cl. G06F 3/12

(52) U.S. Cl. CPC G06F 3/1208; G06F 3/1243

(57) ABSTRACT

A printing system includes first and second printing apparatuses. The second printing apparatus includes a second controller configured to: print a second code image corresponding to a code image on a print medium by a second ejecting head based on print data and a first printing condition; read the second code image printed on the print medium by a second reading device; obtain a first reading result by a first reading device of the first printing apparatus; compare a second reading result by the second reading device with a first reading result; change the first printing condition to a second printing condition different from the first printing condition, based on a comparison result, and reprint the second code image on the print medium by the second ejecting head based on the print data and the changed second printing condition.

### REFERENCE TO RELATED APPLICATIONS

This application claims priority from Japanese Patent Application No. 2023-219467 filed on Dec. 26, 2023. The entire content of the priority application is incorporated herein by reference.

### BACKGROUND ART

Conventionally, a known printing apparatus performs printing on a plurality of labels attached to a mount sheet. Such a mount sheet is formed in a roll shape, and bar codes, etc., are printed on the labels, in some cases.

### SUMMARY

Incidentally, depending on the size of the business, a plurality of printing apparatuses is used to print large quantities of various codes such as the bar codes, in some cases. However, due to the differences in printing precision among the printing apparatuses, the print quality of the bar codes is not necessarily the same among the printing apparatuses. For this reason, a setting change of a correction value is required in each of the printing apparatuses so as to obtain a desired print quality. This leads to such a problem that the load of the setting change increases as the number of printing apparatuses increases.

In view of the above-described situation, the present disclosure aims to provide a printing system, a printing apparatus, and a medium storing a printing program each capable of easily improving the print quality of a code image.

A printing system according to the present disclosure includes: a first printing apparatus including a first ejecting head configured to eject liquid droplets to a print medium, a first reading device configured to read an image, and a first controller; and a second printing apparatus including a second ejecting head configured to eject liquid droplets to a print medium, a second reading device configured to read an image, and a second controller. The first controller is configured to execute: a process of determining a first printing condition for printing a code image on the print medium based on print data; a process of printing a first code image corresponding to the code image on the print medium by causing the first ejecting head to eject the liquid droplets based on the print data and the first printing condition; and a process of causing the first reading device to read the first code image printed on the print medium. The second controller is configured to execute: a process of printing a second code image corresponding to the code image on the print medium by causing the second ejecting head to eject the liquid droplets based on the print data and the first printing condition; a process of causing the second reading device to read the second code image printed on the print medium; a process of obtaining a first reading result by the first reading device; a process of performing a comparison of a second reading result by the second reading device with the first reading result; a process of changing the first printing condition to a second printing condition different from the first printing condition, based on a comparison result; and a process of reprinting the second code image on the print medium by causing the second ejecting head to eject the liquid droplets based on the print data and the second printing condition after the process of changing.

According to the present disclosure, the second printing condition, that is obtained by changing the first printing condition based on the comparison result between the second reading result and the first reading result, is used in the second printing apparatus. With this, the printing can be performed by obtaining the second printing condition to be used in the second printing apparatus, with the first reading result of the first code image printed in the first printing apparatus as the reference. Therefore, the print quality of the second code image printed in the second printing apparatus can be made closer to the print quality of the first code image printed in the first printing apparatus. Further, since the second printing condition to be used in the second printing apparatus is obtained, with the first reading result of the first code image as described above as the reference, the print quality of the second code image in the second printing apparatus can be made closer to the print quality of the first code image in the first printing apparatus more easily as compared with a case where the first printing condition in the first printing apparatus is simply transmitted to and used in the second printing apparatus. Furthermore, a process of adjusting a correction value in the second printing apparatus is not required in a case where the installation environment changes and/or in a case where the kinds of print medium used in the respective printing apparatuses are different. With the foregoing configuration, the print quality of the second code image in the second printing apparatus can be easily improved so as to match the print quality of the first code image in the first printing apparatus, without the occurrence of the load of the setting change of the correction value.

According to the present disclosure, the printing system, the printing apparatus, and the medium storing the printing program can be provided each capable of improving the print quality of the code image.

### BRIEF DESCRIPTION OF DRAWINGS

FIG. 1 is a diagram depicting the schematic configuration of a printing system according to an embodiment.

FIG. 2 is a cross-sectional view depicting a printing apparatus according to the embodiment.

FIG. 3 is a block diagram depicting the configuration of a control system of the printing apparatus of FIG. 1.

FIG. 4 is a diagram depicting the structure of a roll sheet which is an example of a print medium.

FIG. 5A is a diagram depicting an example of a first code image printed by a first printing apparatus, and FIG. 5B is a diagram depicting an example of a second code image printed by a second printing apparatus.

FIG. 6A is a partially enlarged view of the first code image of FIG. 5A, and FIG. 6B is a partially enlarged view of the second code image of FIG. 5B.

FIG. 7 is a flowchart depicting the flow of a process in the first printing apparatus.

FIG. 8 is a flowchart depicting the flow of a process in the second printing apparatus.

FIG. 9 is a flowchart continuing from the flowchart of FIG. 8.

### DESCRIPTION

A printing system, a printing apparatus, and a printing program each according to an embodiment of the present disclosure will be described below with reference to the drawings. Each of the printing apparatus, etc., described below is merely an embodiment of the present disclosure. Therefore, the present disclosure is not limited to the following embodiment, and additions, deletions, and changes are possible within the scope of the present disclosure.

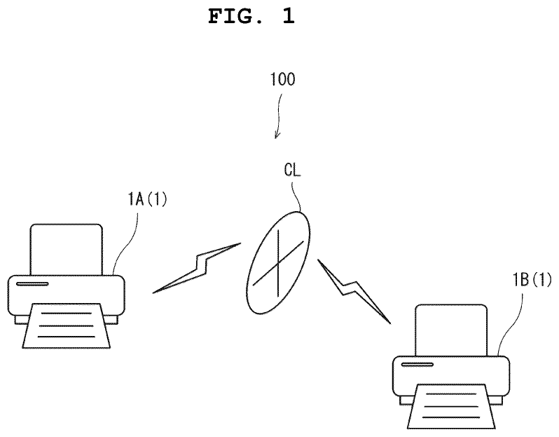

As depicted in FIG. 1, the printing system 100 includes a plurality of printing apparatuses 1, such as ink-jet printers. Each of the printing apparatuses 1 prints an image on a print medium by ejecting a liquid droplet (e.g., a droplet of ink). The printing system 100 includes a first printing apparatus 1A and a second printing apparatus 1B each as the printing apparatus 1. The first printing apparatus 1A and the second printing apparatus 1B have the same configuration. Note that the printing system 100 may include three or more printing apparatuses 1.

The first printing apparatus 1A and the second printing apparatus 1B are connected to each other to be capable of communicating with each other via wired or wireless communication. For example, the first printing apparatus 1A and the second printing apparatus 1B are configured to be capable of communicating with each other via a communication line CL such as the Internet. Note that the first printing apparatus 1A and the second printing apparatus 1B may be connected to each other to be capable of communicating with each other by, for example, wireless communication conforming to Bluetooth standard (Bluetooth is a registered trademark of Bluetooth SIG, Inc. USA) standard. Further, the first printing apparatus 1A and the second printing apparatus 1B may be connected to each other to be capable of communicating with each other by, for example, a LAN (Local Area Network) or the like. Note, however, that the connecting system between the first printing apparatus 1A and the second printing apparatus 1B is not limited to the above-described configurations.

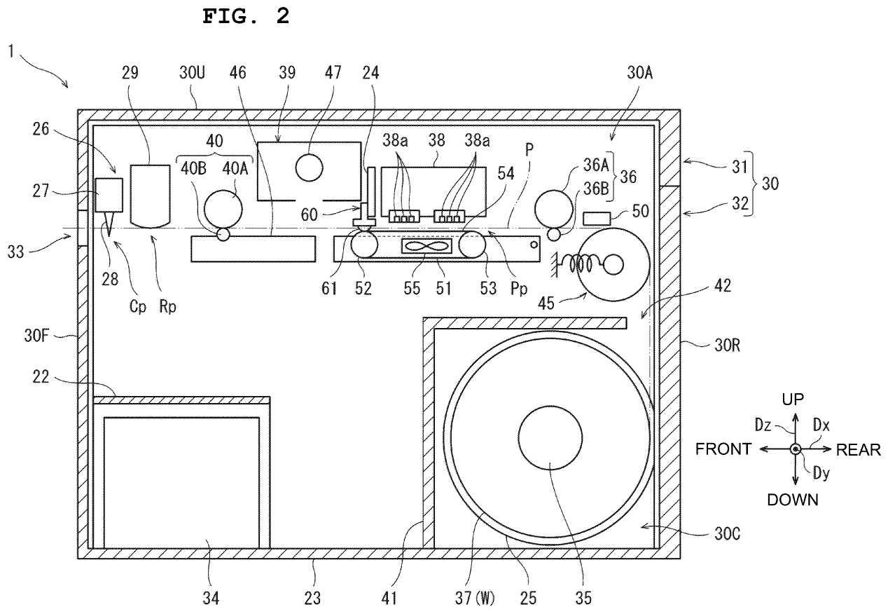

As described above, the first printing apparatus 1A and the second printing apparatus 1B have the same configuration, and thus, except in several cases to be specially mentioned, the first printing apparatus 1A and the second printing apparatus 1B will be described below as the printing apparatus 1. As depicted in FIG. 2, the printing apparatus 1 is, for example, an ink-jet printer which is configured to print an image such as a code image on a label sheet P. The printing apparatus 1 includes a casing 30. The casing 30 has an upper casing 31 and a lower casing 32. The upper casing 31 and the lower casing 32 are, for example, of a rectangular parallelopiped shape and can be placed on a table. Note that the code image will be described later. Further, in FIG. 2, directions which are orthogonal to one another are referred to as a first direction Dx, a second direction Dy, and a third direction Dz. In the present embodiment, for example, the first direction Dx is the front-rear direction, the second direction Dy is the left-right direction, and the third direction Dz is the up-down direction. In the following description, “Dx” is referred to as the front-rear direction, “Dy” is referred to as the left-right direction, and “Dz” is referred to as the up-down direction.

A discharge port 33 extending in the left-right direction Dy is disposed in a front surface 30F of the casing 30. The discharge port 33 communicates an internal space 30A of the casing 30 with the outside. A label sheet P on which an image is printed in the internal space 30A of the casing 30 is discharged to the outside of the casing 30 via the discharge port 33.

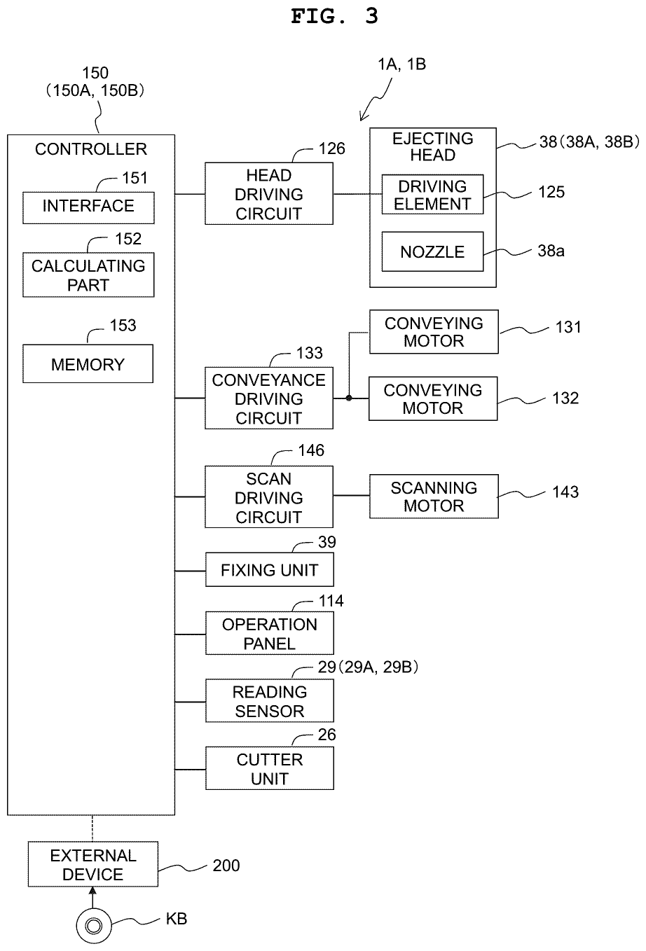

An operation panel 114 (see FIG. 3) is disposed in the front surface 30F of the casing 30. The operation panel 114 is located, for example, above the discharge port 33. A user can use the operation panel 114 so as to operate the printing apparatus 1 and to input a variety of kinds of settings.

A subframe 22 is disposed in a front portion of the internal space 30A of the casing 30. A tank 34 is disposed in a space surrounded by the subframe 22. The tank 34 is, for example, a container of a rectangular parallelopiped shape, and stores an ink inside. The tank 34 is capable of supplying the ink to the ejecting head 38 by a non-illustrated tube. In the following, in a case to be specially mentioned, the ejecting head 38 of the first printing apparatus 1A is referred to as an ejecting head 38A corresponding to a “first ejecting head”, and the ejecting head 38 of the second printing apparatus 1B is referred to as an ejecting head 38B corresponding to a “second ejecting head”. In the present embodiment, the tank 34 can be of a cartridge type detachably attached with respect to the casing 30. The tank 34 may include, for example, four tanks each storing one of four kinds of basic color inks, and one tank or a plurality of tanks storing a special color ink. Examples of the basic color ink include a cyan ink, an yellow ink, a magenta ink, and a black ink. On the other hand, a special color ink is an ink of which color is different from the basic color ink, and examples of such ink include a red ink, a green ink, and a blue ink.

A holder 35, a tensioner 45, a conveying roller 36, a discharging roller 40, an ejecting head 38, for example, of a serial head system, a side guide 50, an attraction-by-suction belt 51, a pressing roller unit 60, a fixing unit 39, a platen 46, a reading sensor 29, a cutter unit 26, and the above-mentioned tank 34 are arranged in the internal space 30A of the casing 30.

A separation wall 41 is disposed in a rear portion of the internal space 30A. The separation wall 41 and the lower casing 32 define a roll sheet accommodating space 30C. The roll sheet accommodating space 30C is a space isolated from the ejecting head 38 and the like. A roll sheet 37 (label sheet P), which is an example of the print medium W, is accommodated in the roll sheet accommodating space 30C.

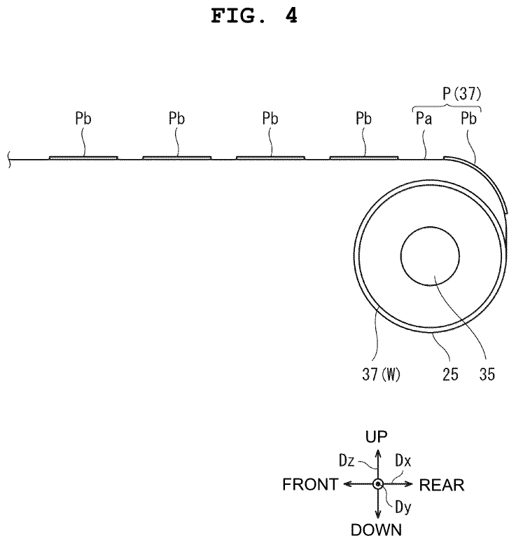

The roll sheet 37 is a label sheet P, having a plurality of labels Pb and a belt-shaped mount sheet Pa to which the plurality of labels Pb is attached, wound in a roll shape as depicted in FIG. 4. The respective labels Pb are attached to the mount sheet Pa with equal spacing distances. A surface of the mount sheet Pa is imparted with releasability. The materials of the mount sheet Pa and the label Pb are not particularly limited.

The roll sheet accommodating space 30C includes a holder 35 extending in the left-right direction Dy. The roll sheet 37 can be mounted on the holder 35. The holder 35 supports the roll sheet 37 to be rotatable around the shaft thereof. The holder 35 includes a pair of side guides 25 separated from each other in the left-right direction Dy. One side guide 25 and the other side guide 25 are configured to be movable in a mutually approaching direction and a separating direction with respect to each other in the left-right direction Dy. The user causes the pair of side guides 25 to make contact, respectively, with a left end and a right end of the roll sheet 37 in accordance with the width (size in the left-right direction Dy) of the roll sheet 37 to be mounted on the holder 35. With this, the roll sheet 37 is positioned with respect to the holder 35.

A gap 42 is defined between the above-described separation wall 41 and a rear surface 30R of the casing 30, i.e., above the rear end of the roll sheet 37. In a case where the conveying roller 36 and the discharging roller 40 rotate, the label sheet P constructing the roll sheet 37 is thereby pulled upward from the rear end of the roll sheet 37 mounted on the holder 35, and is guided to the tensioner 45 through the gap 42.

The tensioner 45 is disposed above the roll sheet accommodating space 30C in the internal space 30A. The tensioner 45 is disposed above the separation wall 41. The tensioner 45 is a roller supported rotatably around a shaft parallel to the left-right direction Dy. The tensioner 45 is biased rearward by, for example, a biasing member such as a spring. The tensioner 45 comes into contact with the label sheet P pulled upward from the roll sheet 37, and guides the label sheet P so that the label sheet P is curved forward.

The conveying roller 36 is disposed in front of the tensioner 45 in the internal space 30A. The conveying roller 36 has a conveying roller 36A and a pinch roller 36B. Each of the conveying roller 36A and the pinch roller 36B is supported to be rotatable about a shaft parallel to the left-right direction Dy. The conveying roller 36A is rotated by a driving force transmitted from the conveying motor 131, thereby conveying the label sheet P forward while nipping the label sheet P between the conveying roller 36A and the pinch roller 36B.

The side guide 50 is disposed in the internal space 30A at a location above the tensioner 45 and behind the conveying roller 36. The side guide 50 is a pair of guides which are separated from each other in the left-right direction Dy, and which come into contact, respectively, with both ends in the left-right direction Dy of the label sheet P which is being conveyed forward, thereby positioning the label sheet P in the left-right direction Dy. The side guide 50 is movable along the left-right direction Dy by, for example, a rack and pinion mechanism.

The discharging roller 40 is disposed in front of the conveying roller 36 in the internal space 30A. The discharging roller 40 has a discharging roller 40A and a pinch roller 40B. Each of the discharging roller 40A and the pinch roller 40B is supported to be rotatable about a shaft parallel to the left-right direction Dy. The discharging roller 40A is rotated by a driving force transmitted from the conveying motor 132, thereby conveying the label sheet P forward while nipping the label sheet P between the discharging roller 40A and the pinch roller 40B.

The ejecting head 38 is disposed in front of the conveying roller 36 in the internal space 30A. The ejecting head 38 has a plurality of nozzles 38a. The ejecting head 38 ejects an ink droplet through each of the plurality of nozzles 38a to a label Pb, of the plurality of labels Pb, of a label sheet P supported by an attraction-by-suction belt 51. With this, a code image, which will be described later, is printed on the label Pb.

The attraction-by-suction belt 51 is disposed in front of the conveying roller 36 and below the ejecting head 38. The attraction-by-suction belt 51 includes two pulleys 52 and 53 which are spaced apart from each other in the front-rear direction Dx and each of which is rotatable around a shaft parallel to the left-right direction Dy, and an endless belt 54 placed to be stretched between the two pulleys 52 and 53. The pulley 52 rotates due to the driving force of a non-illustrated motor. The endless belt 54 rotates due to the rotation of the pulley 52. A plurality of through holes is formed in the endless belt 54. A fan 55 disposed on the attraction-by-suction belt 51 is operated to generate negative pressure below the endless belt 54. With this, the label sheet P is attracted, by suction, to the endless belt 54 through the plurality of through holes. In this manner, the attraction-by-suction belt 51 conveys the label sheet P forward while attracting the label sheet P thereto by suction.

The pressing roller unit 60 is disposed in front of the ejecting head 38 in the internal space 30A. The pressing roller unit 60 is supported by a head frame 24 together with the ejecting head 38. The pressing roller unit 60 has a pressing roller 61. The head frame 24 is movable along the up-down direction Dz. As the head frame 24 moves in the up-down direction Dz, the ejecting head 38 is thereby movable between a predetermined ejection position and a separated position which is separated upward from the attraction-by-suction belt 51 with respect to the ejection position. Accompanying with this, the pressing roller 61 of the pressing roller unit 60 is movable between a contact position at which the pressing roller 61 makes contact with the label sheet P and a separated position at which the pressing roller 61 is separated upward from the label sheet P. In a case where the ejecting head 38 is positioned at the ejection position, the pressing roller 61 is positioned at the contact position.

The fixing unit 39 is disposed, in the internal space 30A, in front of the ejecting head 38 and the pressing roller unit 60 and behind the discharging roller 40. The fixing unit 39 is, for example, an ultraviolet light irradiator. A UV lamp 47 is disposed inside the fixing unit 39. The fixing unit 39 irradiates the ink on the label Pb of the label sheet P with ultraviolet light generated by the UV lamp 47. A resin contained in the ink irradiated with the ultraviolet light is cured, and the pigment contained in the ink is thereby fixed to the label Pb. Note that the fixing unit 39 is not limited to the ultraviolet light irradiator. For example, in a case where the ink contains thermoplastic resin fine particles, the fixing unit 39 may be a heater having an IR lamp as a heating member.

The platen 46 is disposed in front of the ejecting head 38 and the attraction-by-suction belt 51 in the internal space 30A. A rear part of the platen 46 faces the fixing unit 39. A front part of the platen 46 faces the discharging roller 40A. The platen 46 supports the label sheet P conveyed forward by the attraction-by-suction belt 51.

The reading sensor 29 is disposed at an intermediate location in a conveyance route of the label sheet P. In the following, in a case to be specifically mentioned, the reading sensor 29 of the first printing apparatus 1A is referred to as a reading sensor 29A which corresponds to a “first reading device”, and the reading sensor 29 of the second printing apparatus 1B is referred to as a reading sensor 29B which corresponds to a “second reading device”.

The reading sensor 29 is disposed in front of the discharging roller 40. The reading sensor 29 mainly includes a light source such as an LED, etc., a refractive index distribution type lens, and a line sensor. A reflection light emitted from the light source and reflected by the label sheet P is collected to the line sensor by the refractive index distribution type lens. The reading sensor 29 outputs an electric signal in accordance with the intensity of the reflection light received by the line sensor. The reading sensor 29 reads an image such as a code image, which will be described later, printed on the label Pb of the label sheet P.

The cutter unit 26 is disposed in front of the reading sensor 29. The cutter unit 26 has a cutter carriage 27 and a cutter 28 mounted on the cutter carriage 27. The cutter carriage 27 moves in the left-right direction Dy by a non-illustrated belt driving mechanism, etc. The cutter 28 also moves in the left-right direction Dy accompanying with the movement of the cutter carriage 27. By the movement of the cutter 28, a part of the label paper P is cut along the left-right direction Dy, the part being one of locations which are positioned between labels Pb included in the plurality of labels Pb and being positioned between the discharging roller 40 and the discharge port 33. In other words, the cutter unit 26 cuts the label sheet P pulled from the roll sheet 37.

As depicted in FIG. 3, each of the ejecting head 38A and the ejecting head 38B has a plurality of driving elements 125. Each of the plurality of driving elements 125 is a piezoelectric element, a heating element, an electrostatic actuator, etc., and each of the plurality of driving elements 125 is disposed corresponding to one of the plurality of nozzles 38a of the ejecting head 38A and the ejecting head 38B, and applies pressure to the ink so as to eject an ink droplet from the nozzle 38a corresponding thereto.

In addition to the above-described constituent components, the printing apparatus 1 further includes a controller 150. In the following description, in a case to be specifically mentioned, the controller 150 of the first printing apparatus 1A is referred to as a controller 150A which corresponds to a “first controller”, and the controller 150 of the second printing apparatus 1B is referred to as a controller 150B which corresponds to a “second controller”.

The controller 150 includes an interface 151, a calculating part 152 corresponding to a “computer”, and a memory 153. The interface 151 receives a variety of kinds of data such as print data, etc., from an external device 200 including, for example, another printing apparatus, a server device, an imaging device, a reading device configured to read a printing program stored, for example, in a storage medium KB such as a CD-ROM, etc., and a display, etc. The print data is, for example, raster data indicating a code image to be printed on a label Pb as the print medium W. The printing program is configured to cause the computer of each of the first printing apparatus 1A and the second printing apparatus 1B in the printing system 100 to execute each of the processes described below. Note that the printing program may be installed in either one of the first printing apparatus 1A or the second printing apparatus 1B via a communication network or by reading the storage medium KB by the above-described reading device. In this case, the calculating part 152 of the controller 150 in the printing apparatus 1 which is one of the first and second printing apparatuses 1A and 1B and in which the printing program is installed may control the respective components of the printing apparatus 1, and may transmit a control command to the calculating part 152 of the controller 150 in another printing apparatus 1 which is the other of the first and second printing apparatuses 1A and 1B. Alternatively, the printing program may be installed in both the first printing apparatus 1A and the second printing apparatus 1B. In this case, the calculating part 152 of the controller 150A in the first printing apparatus 1A and the calculating part 152 of the controller 150B in the second printing apparatus 1B cooperate to cause each of the respective components of the first printing apparatus 1A and each of the respective components of the second printing apparatus 1B to execute a process based on the printing program.

The memory 153 stores a variety of kinds of data, which are, for example, the print data, information related to a printing condition, and data related to a reading result by the reading sensor 29, etc. The memory 153 is a memory accessible from the calculating part 152, and includes RAM and ROM. The RAM temporarily stores a variety of kinds of data, such as data received from the external device 200, such as the print data and the information related to the printing condition, data converted by the calculating part 152, etc. The ROM stores the printing program and the variety of kinds of data, etc.

The calculating part 152 includes at least one circuit, such as a processor such as a CPU and an integrated circuit such as an ASIC, etc. The calculating part 152 controls the respective parts by executing the printing program, and executes a variety of kinds of operations, such as a print operation, etc.

The controller 150 is electrically connected to the conveying motors 131 and 132 via a conveyance driving circuit 133, and controls the driving of each of the conveying motors 131 and 132. With this, the conveyance of the label sheet P by the conveying roller 36 and the discharge roller 40 is controlled. Further, the controller 150 is electrically connected to the scanning motor 143 via a scan driving circuit 146, and controls the driving of the scanning motor 143. With this, the movement of the ejecting head 38 is controlled. Furthermore, the controller 150 is electrically connected to the plurality of driving elements 125 via a head driving circuit 126. The controller 150 outputs a control signal of each of the plurality of driving elements 125 to the head driving circuit 126, and the head driving circuit 126 generates a driving signal based on the control signal and outputs the driving signal to each of the plurality of driving elements 125. Each of the plurality of driving elements 125 is driven based on the driving signal, whereby an ink droplet is ejected, toward the label Pb, from one of the plurality of nozzles 38 corresponding to each of the plurality of driving elements 125.

Further, the controller 150 receives input information from the operation panel 114 so as to execute a predetermined process, and controls the operation of each of the fixing unit 39 and the cutter unit 26. Furthermore, the controller 150 receives the reading result by the reading sensor 29.

Next, a process of the first printing apparatus 1A and a process of the second printing apparatus 1B in the printing system 100 will be described.

The controller 150A of the first printing apparatus 1A executes a process of determining a first printing condition for printing the code image CG on the label Pb as the print medium W, based on the print data. Here, examples of the first printing condition include the volume of the ink droplet to be ejected, the spacing distance between ink droplets to be ejected, the line width of the code image CG, the inclination of the ejecting head 38 with respect to a horizontal plane, and a correction amount of the conveying roller 36, etc., and the like. The first printing condition may include at least one item among the above-described exemplified plurality of items. Note, however, that the first printing condition is not limited to those described above, and any condition regarding the printing may be included in the first printing condition. The first printing condition can be set by a user, for example, via the operation panel 114, etc. The controller 150A stores, in the memory 153 such as the memory, etc., the first printing condition input by the user, as a printing condition in a case where the first code image CG1 described later, as the code image CG, is printed. With this, the first printing condition for printing the code image CG on the label Pb based on the print data is determined (set) by the controller 150A.

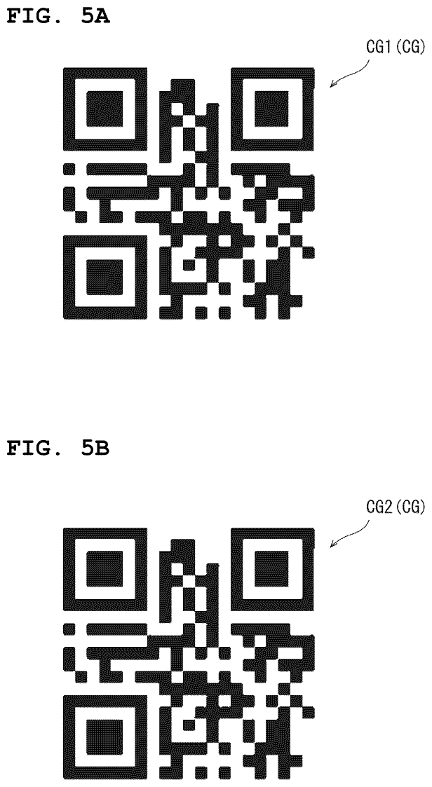

The controller 150A executes a process of printing the first code image CG1 corresponding to the code image CG on the label Pb by causing the ejecting head 38A to eject ink droplets based on the print data and the first printing condition. In this case, the controller 150A causes the ejecting head 38A to eject the ink droplets onto the label Pb while moving the ejecting head 38A in a direction parallel to the left-right direction Dy in a printing pass. Further, the controller 150A conveys the label sheet P forward in the front-rear direction Dx in a conveying operation. In such a manner, the controller 150A alternately repeats the printing pass and the conveying operation. With this, the first code image CG1 is printed on the label Pb. Note that the print data may be obtained from the external device 200 as described above, or may be generated in the first printing apparatus 1A. The first code image CGI printed by the ejecting head 38A is, for example, a two-dimensional code image as depicted in FIG. 5A. Note, however, that the first code image CG1 may be any image having information, and may be, for example, another code image such as a bar code image.

The controller 150A executes a process of causing the reading sensor 29A to perform reading of the first code image CG1 printed on the label Pb. In a case where the first code image CG1 is read by the reading sensor 29A, a first reading result, which is the reading result of the first code image CG1, is thereby obtained. Further, the controller 150A transmits the print data, information related to the first printing condition, and the first reading result by the reading sensor 29A to the second printing apparatus 1B.

Next, the controller 150B of the second printing apparatus 1B receives, via the interface 151, the print data, the information related to the first printing condition, and the first reading result transmitted from the controller 150A.

The controller 150B uses the first printing condition received from the first printing apparatus 1A. In this case, the controller 150B executes a process of printing the second code image CG2 corresponding to the code image CG on the label Pb by causing the ejecting head 38B to eject ink droplets based on the print data and the first printing condition. Note that the aspect of printing using the ejecting head 38B by the controller 150B is the same as the above-described aspect of printing using the ejecting head 38A by the controller 150A.

The controller 150B executes a process of causing the reading sensor 29B to perform reading of the second code image CG2 printed on the label Pb. In a case where the second code image CG2 is read by the reading sensor 29B, a second reading result, which is the reading result of the second code image CG2, is obtained.

The controller 150B executes a comparing process of performing comparison of the second reading result by the reading sensor 29B with the first reading result by the reading sensor 29A. The controller 150B executes a process of changing the first printing condition to a second printing condition, which is a printing condition different from the first printing condition, based on a comparison result. The comparing process will be described in detail below.

In the comparison, the controller 150B performs pattern matching between, for example, the first code image CG1 in the first reading result and the second code image CG2 in the second reading result.

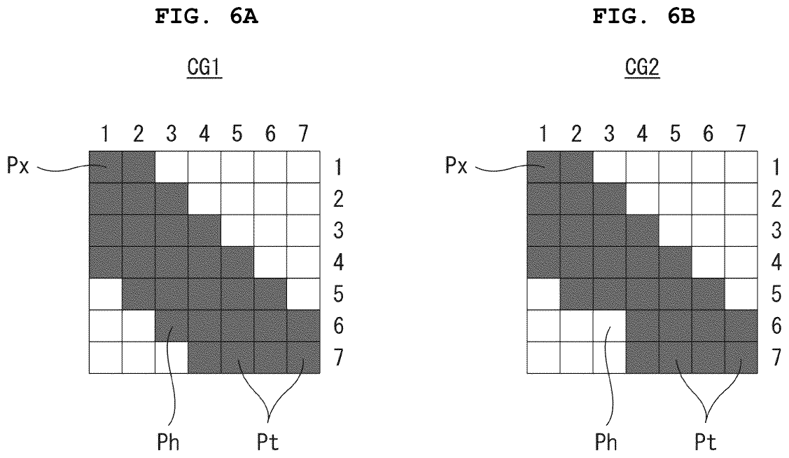

The pattern matching between the first code image CG1 and the second code image CG2 will be described, with reference to FIGS. 6A and 6B. Note that in the description of FIG. 6A and FIG. 6B, a position of each of pixels Px disposed in a lattice pattern is specified by row and column.

In FIG. 6A, a plurality of pixels Px constructing first code image CG1 are painted black, and in FIG. 6B, a plurality of pixels Px constructing the second code image CG2 are painted black. In the first code image CG1, a pixel Px positioned in the 6th row and 3rd column constructs an image. On the other hand, in the second code image CG2, a pixel Px positioned in the 6th row and 3rd column does not construct an image. Note that the construction or non-construction of the image by all pixels Px, of the plurality of pixels, which are other than the pixel Px in the 6th row and 3rd column in the first code image CG1 is the same as the construction or non-construction of the image by all pixels Px, of the plurality of pixels, which are other than the pixel Px in the 6th row and 3rd column in the second code image CG2.

In such a manner, the pixel Px positioned in the 6th row and 3rd column which constructs the image in the first code image CG1 does not match the pixel Px positioned in the 6th row and 3rd column which does not construct the image in the second code image CG2. In this case, the controller 150B counts the pixel Px positioned in the 6th row and 3rd column in the first code image CG1 and the pixel Px positioned in the 6th row and 3rd column in the second code image CG2 as non-matching pixels Ph which do not match each other. The controller 150B performs the count for each combination of a non-matching pixel Ph in the first code image CG1 and a non-matching pixel Ph in the second code image CG2. In FIGS. 6A and 6B, the count number of non-matching pixels Ph is 1 (one).

On the other hand, the controller 150B counts the pixels Px, of the plurality of pixels, each of which constructs the image and which are other than the pixel Px in the 6th row and 3rd column (i.e., the blackened pixels Px) in the first code image CG1 and the pixels Px, of the plurality of pixels, each of which constructs the image and which are other than the pixel Px in the 6th row and 3rd column in the second code image CG2 as matching pixels Pt. The controller 150B performs the count for each combination of a matching pixel Pt in the first code image CG1 and a matching pixel Pt in the second code image CG2. In FIGS. 6A and 6B, the count number of matching pixels Pt is 27.

Next, the controller 150B executes a process of determining whether or not a matching number (i.e., the count number of matching pixels Pt) is less than a threshold value, the matching number indicating a number of the pixel Px constructing the first code image CG1 and the pixel Px constructing the second code image CG2 which match each other. This threshold value may be a value which can be set by the user. In a case where the controller 150B determines that the count number of matching pixels Pt is less than the threshold value, the controller 150B executes a process of changing the above-described first printing condition to a second printing condition which is the printing condition different from the first printing condition. Note that the case where the count number of matching pixels Pt is less than the threshold value means that although the printing has been performed in the second printing apparatus 1B based on the same printing condition as the first printing condition used in the first printing apparatus 1A, a difference in the printing precision (printing quality) to a certain extent occurs between the first code image CG1 and the second code image CG2. On the other hand, in a case where the count number of matching pixels Pt is equal to or greater than the threshold value, the controller 150B does not execute the process of changing the first printing condition to the second printing condition. Note that the case where the count number of matching pixels Pt is equal to or greater than the threshold value means that the printing performed in the second printing apparatus 1B based on the same printing condition as the first printing condition used in the first printing apparatus 1A results in no occurrence of the difference in the printing precision (printing quality) to the certain extent between first code image CG1 and second code image CG2.

Similarly to the first printing condition, examples of the second printing condition include the volume of an ink droplet to be ejected, the spacing distance between ink droplets to be ejected, the line width of the code image CG, the inclination of the ejecting head 38 with respect to the horizontal plane, and the correction amount of the conveying roller 36, etc., and the like. The second printing condition may include at least one item of the above-described exemplified plurality of items. The second printing condition may differ from the first printing condition in a numerical value of the at least one item of the above-described items. In a case where the second controller 150B changes the first printing condition to the second printing condition, the controller 150B may, for example, use the resolution of the second printing condition as a unit of change, based on the priority order of the second printing condition set in advance by the user. In a case where the second printing condition with a higher priority order set in advance by the user is, for example, the volume of the ink droplet, the volume may be changed with the resolution of the volume as a unit. Further, the second printing condition of which priority order is high may include a plurality of second printing conditions; in this case, each of the plurality of second printing conditions may be changed. The controller 150B causes the second memory 153 such as the memory, etc., to store the second printing condition, as the printing condition in a case where the second code image CG2 is to be printed. In this manner, the second printing condition is determined (set) by the controller 150B.

The controller 150B executes a process of reprinting the second code image CG2 on the label Pb by causing the ejecting head 38B to eject ink droplets based on the print data and the second printing condition after the process of changing. Note that the label Pb on which the second code image CG2 is (to be) printed based on the second printing condition after the process of changing may be different from a previous label Pb on which the second code image CG2 has been printed based on the first printing condition.

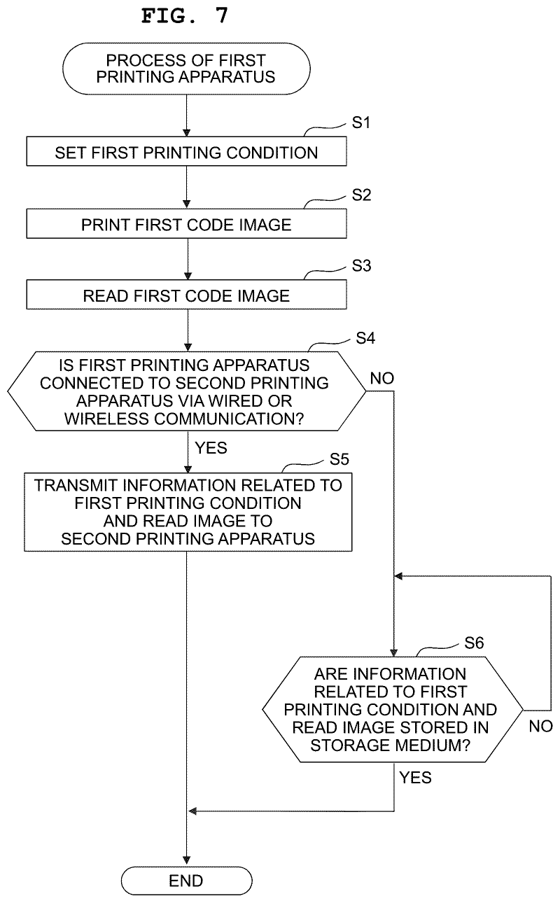

Next, a process of the first printing apparatus 1A and a process of the second printing apparatus 1B in the printing system 100 will be described by using flowcharts, respectively, of FIGS. 7 to 9.

As depicted in FIG. 7, the controller 150A of the first printing apparatus 1A sets the first printing condition for printing the first code image CGI on a label Pb based on the print data (step S1). Next, the controller 150A causes the ejecting head 38 to print the first code image CG1 on the label Pb based on the print data and the first printing condition (step S2).

The controller 150A causes the reading sensor 29A to read the first code image CG1 printed on the label Pb (step S3). Then, the controller 150A determines whether or not the first printing apparatus 1A is connected to the second printing apparatus 1B by the wired or wireless communication (step S4).

In a case where the controller 150A determines that the first printing apparatus 1A is connected to the second printing apparatus 1B by the wired or wireless communication (step S4: YES), the controller 150A transmits the print data, the information related to the first printing condition and the first reading result by the reading sensor 29A (hereinafter abbreviated as “information related to the first printing condition, etc.”) to the second printing apparatus 1B (step S5), and ends the process. Note that the second printing apparatus 1B may obtain the print data from the first printing apparatus 1A as described above, or may obtain the print data from another external device 200. On the other hand, in a case where the controller 150A determines that the first printing apparatus 1A is not connected to the second printing apparatus 1B by the wired or wireless communication (step S4: NO), the controller 150A determines whether or not the information related to the first printing condition, etc., has been stored in the storage medium KB via the reading device as the external device 200 (step S6). In this case, since the first printing apparatus 1A is not connected to the second printing apparatus 1B, the user performs an operation of storing the information related to the first printing condition, etc., in the storage medium KB so that the information related to the first printing condition, etc., can be read by the second printing apparatus 1B.

In a case where the controller 150A determines that the process of storing the information related to the first printing condition, etc., in the storage medium KB has been executed (step S6: YES), the controller 150A ends the process. In this case, the controller 150A ends the process in a case where the controller 150B has executed the process of storing information relating to the first printing condition, etc., in the storage medium KB via the reading device as the external device 200. On the other hand, in a case where the controller 150A determines that the information related to the first printing condition, etc., is not stored in the storage medium KB (step S6: NO), the controller 150A stands by until the information related to the first printing condition, etc., is stored in the storage medium KB.

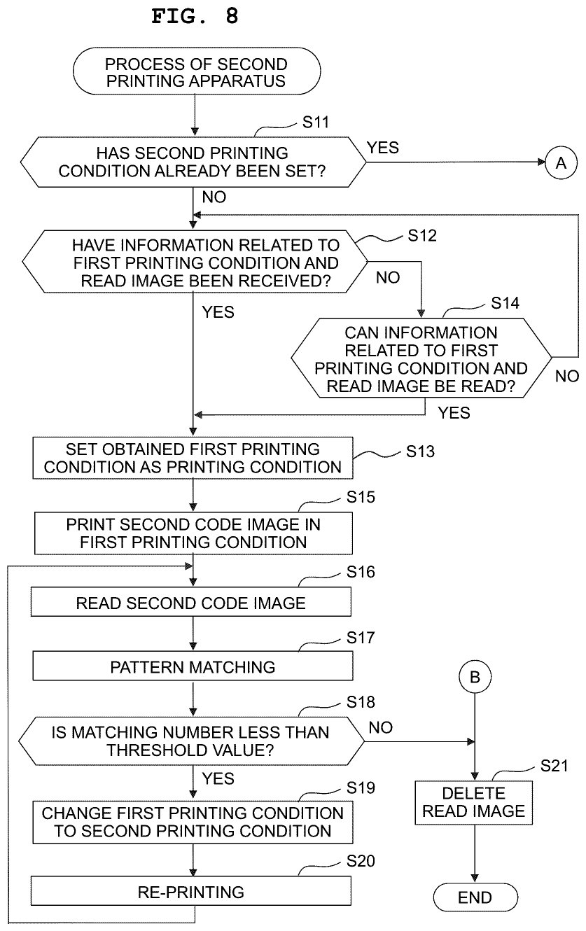

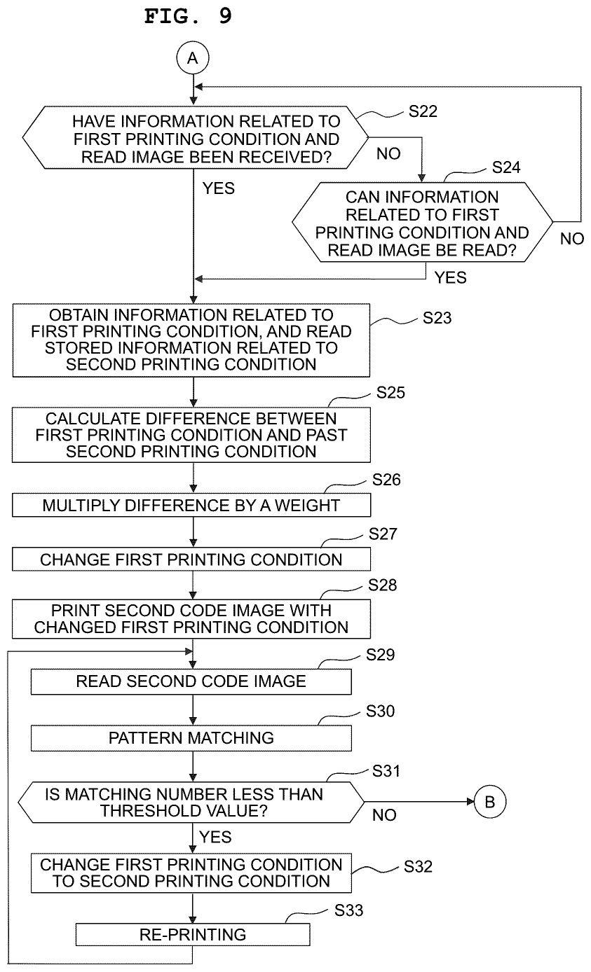

Next, as depicted in FIG. 8, the controller 150B of the second printing apparatus 1B determines whether or not the second printing condition has been set (step S11). In this case, the controller 150B determines whether or not information related to the second printing condition is stored in the memory 153. In a case where the controller 150B determines that the second printing condition has been set, that is, in a case where the controller 150B determines that the second printing condition has been set in the past (step S11: YES), the controller 150B proceeds to a process of step S22 depicted in FIG. 9. Note that the process of step S22 and subsequent processes to step S22 will be explained later.

On the other hand, in a case where the controller 150B determines that the second printing condition has not been set (step S11: NO), the controller 150B determines whether or not the information related to the first printing condition, etc., has been received (step S12). In a case where the controller 150B determines that the information related to the first printing condition, etc., has not been received (step S12: NO), the controller 150B determines whether or not the information related to the first printing condition, etc., can be read from the memory 153 (step S14). In this case, the user causes, in advance, the memory 153 of the second printing apparatus 1B to store, via the reading device of the second printing apparatus 1B, the information related to the first printing condition, etc., which has been stored in the storage medium KB such as a USB flash memory. In a case where the controller 150B determines that the information related to the first printing condition, etc., cannot be read from the memory 153 (step S14: NO), the controller 150B returns to the process of step S12 and repeats the process of step S12 and the processes subsequent thereto.

In a case where the controller 150B determines that the information related to the first printing condition, etc., has been received (step S12: YES), and in a case where the controller 150B determines that the information related to the first printing condition, etc., can be read from the memory 153 (step S14: YES), then controller 150B sets the obtained first printing condition as the printing condition in the second printing apparatus 1B (step S13).

Next, the controller 150B causes the ejecting head 38B to print the second code image CG2 corresponding to the code image CG on the label Pb based on the print data and the first printing condition (step S15). Then, the controller 150B causes the reading sensor 29B to read the second code image CG2 printed on the label Pb (step S16).

Next, the controller 150B performs the pattern matching between the first code image CG1 in the first reading result and the second code image CG2 in the second reading result (step S17). Then, the controller 150B determines whether or not the count number of matching pixels Pt is less than the threshold value (step S18).

In a case where the controller 150B determines that the count number of matching pixels Pt is not less than the threshold value (step S18: NO), the controller 150B deletes the first code image CG1 in the first reading result and the second code image CG2 in the second reading result (step S21), and ends the process.

On the other hand, in a case where the controller 150B determines that the count number of matching pixels Pt is less than the threshold value (step S18: YES), the controller 150B changes the first printing condition to the second printing condition (step S19), and then causes the ejecting head 38B to reprint the second code image CG2 on the label Pb based on the print data and the second printing condition after the process of changing (step S20). Note that after executing the process of step S20, the controller 150B returns to the process of step S16 described above and repeats the process of step S16 and the processes subsequent thereto.

In the following, the process of step 22 and the processes subsequent thereto will be described. Note that the process of step 22 and the processes subsequent thereto are executed, for example, in a case where the second printing condition is updated periodically (once a month, etc.) in the second printing apparatus 1B.

First, the controller 150B determines whether or not the information related to the first printing condition, etc., has been received (step S22). In a case where the controller 150B determines that the information related to the first printing condition, etc., has not been received (step S22: NO), the controller 150B determines whether or not the information related to the first printing condition, etc., can be read from the memory 153 (step S24). In a case where the controller 150B determines that the information related to the first printing condition, etc., cannot be read from the memory 153 (step S24: NO), the controller 150B returns to the process of step S22 and repeats the process of step S22 and the processes subsequent thereto.

In a case where the controller 150B determines that the information related to the first printing condition, etc., has been received (step S22: YES), and in a case where the controller 150B determines that the information related to the first printing condition, etc., can be read from memory 153 (step S24: YES), then the controller 150B obtains the first printing condition and reads, from memory 153, a past second printing condition as the second printing condition which has been previously obtained before the first printing condition (step S23).

The controller 150B executes a process of calculating a difference between the first printing condition and the past second printing condition (step S25). For example, in a case where each of the first printing condition and the second printing condition is the line width of the code image CG, and where the line width in the first printing condition is 3 mm and the line width in the second printing condition is 2.5 mm, the difference is 0.5 mm. Then, the controller 150B multiplies the difference by a weight (step S26). In this case, the controller 150B can use an eigenvalue of the second printing apparatus 1B as the weight. The eigenvalue of the second printing apparatus 1B may be, for example, an adjustment value with respect to the first printing apparatus 1A, or a value in which the degradation of a constituent part (for example, the ejecting head 38B and the conveying roller 36, etc.,) due to the lapse of time is considered.

The controller 150B executes a process of changing the first printing condition based on the difference multiplied by the weight (step S27). Next, the controller 150B causes the ejecting head 38B to print the second code image CG2 on the label Pb based on the print data and the changed first printing condition (step S28). Further, the controller 150B causes the reading sensor 29B to read the second code image CG2 printed on label Pb (step S29).

Next, the controller 150B performs the pattern matching between the first code image CG1 in the first reading result which has been already obtained in the foregoing and the second code image CG2 in the second reading result (step S30). Then, the controller 150B determines whether or not the count number of matching pixels Pt is less than the threshold value (step S31).

In a case where the controller 150B determines that the count number of matching pixels Pt is not less than the threshold value (step S31: NO), the controller 150B proceeds to the process of step S21 described above. On the other hand, in a case where the controller 150B determines that the count number of matching pixels Pt is less than the threshold value (step S31: YES), the controller 150B changes the changed first printing condition to the second printing condition (step S32), and then causes the ejecting head 38B to reprint the second code image CG2 on the label Pb based on the print data and the second printing condition after the process of changing (step S33). After executing the process of step S33, the controller 150B returns to the process of step S29 described above and repeats the process of step S29 and the processes subsequent thereto.

As described above, according to the printing system 100, the second printing condition obtained by changing the first printing condition based on the comparison result between the second reading result and the first reading result is used in the second printing apparatus 1B. With this, the printing can be performed by obtaining the second printing condition to be used in the second printing apparatus 1B, with the first reading result of the first code image CG1 printed in the first printing apparatus 1A as the reference. Therefore, the print quality of the second code image CG2 which is to be printed in the second printing apparatus 1B can be made closer to the print quality of the first code image CG1 which has been printed in the first printing apparatus 1A. Further, since the second printing condition to be used in the second printing apparatus 1B is obtained, with the first reading result of the first code image CG1 as the reference, as described above, the print quality of the second code image CG2 in the second printing apparatus 1B can be made closer to the print quality of the first code image CG1 in the first printing apparatus 1A more easily than in a case where the first printing condition in the first printing apparatus 1A is simply transmitted to and to be used in the second printing apparatus 1B. Furthermore, in a case where the installation environment is changed and/or in a case where the kinds of the labels Pb as the print medium W used in each of the respective printing apparatuses are different between the first and second printing apparatuses 1A and 1B, the process of adjusting the correction value in the second printing apparatus 1B becomes unnecessary. With the foregoing configuration, the print quality of the second code image CG2 in the second printing apparatus 1B can be easily improved so as to match the print quality of the first code image CG1 in the first printing apparatus 1A, without the occurrence of the load of the setting change of the correction value.

Moreover, in the present embodiment, in a case where the controller 150B determines whether or not the matching number (i.e., the count number of matching pixels Pt) which is the number of the pixels Px constructing the first code image CG1 and the pixels Px constructing the second code image CG2 and matching each other is less than the threshold value, the pattern matching between the first code image CG1 and the second code image CG2 is executed. This allows the matching number to be obtained easily and with high accuracy. Therefore, a case wherein the first printing condition needs to be changed to the second printing condition can be clearly determined.

Further, in the present embodiment, the print data, the information related to the first printing condition, and the first reading result are concurrently transmitted to the second printing apparatus 1B. This eliminates the need for a process of transmitting the print data, the information related to the first printing condition, and the first reading result separately in a plurality of transmissions, thereby simplifying the process in the first printing apparatus 1A.

Furthermore, in the present embodiment, the difference between the first printing condition and the past second printing condition is calculated, and the first printing condition is changed based on this difference. This allows the first printing condition to be appropriately changed based on the extent (amount) of the difference.

Moreover, in the present embodiment, the above-described difference is multiplied by the weight. With this, for example, the difference in which the adjustment value with respect to the first printing apparatus 1A or the degradation of a constituent part (for example, the ejecting head 38B and the conveying roller 36, etc.,) due to the lapse of time is considered can be obtained. Therefore, the first printing condition can be changed more appropriately. Further, in the present embodiment, the print data, the information related to the first printing condition, and the first reading result transmitted by the controller 150A are concurrently received by the controller 150B via the interface 151. This eliminates the need for a process of receiving the print data, the information related to the first printing condition, and the first reading result separately in a plurality of times, thereby simplifying the process in second printing apparatus 1B.

The present disclosure is not limited to the above-described embodiment, and can be modified without departing from the gist of the present disclosure. For example, the present disclosure can be modified as follows.

In the above-described embodiment, although the roll sheet 37 in which the label sheet P is wound in the roll shape is used as an example of the print medium W, the present disclosure is not limited to this. A modification of the print medium W is exemplified by a roll sheet such as a receipt in which labels are not attached to the mount sheet (i.e., a roll sheet which is not separated into a mount sheet and labels). Alternatively, a print sheet may be used as the print medium W, rather than using the roll sheet.

Further, in the above-described embodiment, the pattern matching is exemplified as the process of comparing the second reading result by the reading sensor 29B with the first reading result by the reading sensor 29A, the present disclosure is not limited to this. For example, the comparing process may be executed by artistic intelligence of which learning method is deep learning with a neural network.

Furthermore, in the above-described embodiment, the controller 150B of the second printing apparatus 1B obtains the first reading result from the first printing apparatus 1A via the wired or wireless communication system, or reads out the first reading result stored in the storage medium KB via the reading device serving as the external device 200. The present disclosure, however, is not limited to this. The user may manually carry a label Pb on which the first code image CG1 is printed to the second printing apparatus 1B and have the reading sensor 29 of the second printing apparatus 1B read the first code image CGI on the label Pb. This method also allows the second printing apparatus 1B to obtain the first reading result.

Moreover, in the above-described embodiment, the printing apparatus 1 is of the serial head system. The present disclosure, however, is not limited to this; the printing apparatus 1 may be of a line head system.

Moreover, in the above-described embodiment, although the printing apparatus 1 is exemplified by the ink-jet printer, the present disclosure is not limited to this. The printing apparatus 1 may be another printer such as a laser printer, a thermal printer, etc. The laser printer includes a printing part. The printing part of the laser printer includes: an image carrier such as a photosensitive drum, a photosensitive belt, etc.; a charging part; an exposing part; a toner cartridge, a developer cartridge, etc.; a transferring part; and a fixing part. The charging part charges the image carrier in a contact manner or in a non-contact manner. The exposing part uses a laser semiconductor, etc., so as to form an electrostatic latent image on the image carrier which has been charged. The toner cartridge, the developer cartridge, etc., supply a toner to the image carrier on which the electrostatic latent image is formed. The transferring part includes a transfer roller, a transfer belt, etc., and transfers a toner image developed on the image carrier directly to a print medium. The fixing part includes a fixing roller, a fixing belt, etc., and thermally fixes, to the print medium, the toner transferred to the print medium. Further, for example, the printing apparatus 1 may also be a laser printer of an intermediate transfer system, without being limited to the above-described laser printer of the direct tandem type; in the laser printer of the intermediate transfer system, a toner image developed on the image carrier is transferred to an intermediate transfer belt, and then the transfer part is used so as to transfer the toner image from the intermediate transfer belt to the print medium. Further, the thermal printer includes a printing part. The printing part of the thermal printer includes a thermal head and an ink ribbon. The thermal head makes contact with the ink ribbon; in a case where the ink of the ink ribbon is transferred to the print medium, a heating element corresponding thereto is caused to generate heat, thereby transferring the ink of the ink ribbon to the print medium.

What is claimed is:

1. A printing system comprising:
a first printing apparatus including a first ejecting head configured to eject liquid droplets to a print medium, a first reading device configured to read an image, and a first controller; and
a second printing apparatus including a second ejecting head configured to eject liquid droplets to a print medium, a second reading device configured to read an image, and a second controller,
wherein the first controller is configured to execute:
a process of determining a first printing condition for printing a code image on the print medium based on print data;
a process of printing a first code image corresponding to the code image on the print medium by causing the first ejecting head to eject the liquid droplets based on the print data and the first printing condition; and
a process of causing the first reading device to read the first code image printed on the print medium, and
the second controller is configured to execute:
a process of printing a second code image corresponding to the code image on the print medium by causing the second ejecting head to eject the liquid droplets based on the print data and the first printing condition;
a process of causing the second reading device to read the second code image printed on the print medium;
a process of obtaining a first reading result by the first reading device;
a process of performing a comparison of a second reading result by the second reading device with the first reading result;
a process of changing the first printing condition to a second printing condition different from the first printing condition, based on a comparison result; and
a process of reprinting the second code image on the print medium by causing the second ejecting head to eject the liquid droplets based on the print data and the second printing condition after the process of changing.

2. The printing system according to claim 1, wherein
the second controller is configured to execute:
a process of performing pattern matching between the first code image in the first reading result and the second code image in the second reading result in the comparison, and of determining whether a matching number is less than a threshold value, the matching number indicating the number of pixels constructing both the first code image and the second code image; and
the process of changing the first printing condition to the second printing condition in a case where the matching number is less than the threshold value.

3. The printing system according to claim 1, wherein
the first printing apparatus and the second printing apparatus are connected to communicate with each other via wired or wireless communication,
the first controller is configured to transmit the first printing condition and the first reading result to the second printing apparatus, and
the second controller is configured to use the first printing condition received from the first printing apparatus.

4. The printing system according to claim 1, wherein
the second controller is configured to execute:
a process of calculating a difference between the first printing condition and a past second printing condition as the second printing condition obtained before the first printing condition; and
the process of changing the first printing condition to the second condition, based on the difference.

5. The printing system according to claim 4, wherein the second controller is configured to multiply the difference by a weight.

6. The printing system according to claim 1, wherein
the first printing apparatus and the second printing apparatus are connected to communicate with each other via wired or wireless communication, and
the second controller is configured to receive the first printing condition and the first reading result from the first printing apparatus.

7. A printing apparatus comprising:
an ejecting head configured to eject liquid droplets to a print medium;
a reading device configured to read an image; and
a controller,
wherein the controller is configured to execute:
a process of obtaining print data, a first printing condition for printing a code image on the print medium based on the print data, and a first reading result of a first code image corresponding to the code image, from another printing apparatus;
a process of printing a second code image corresponding to the code image on the print medium by causing the ejecting head to eject the liquid droplets based on the print data and the first printing condition;
a process of causing the reading device to read the second code image printed on the print medium;
a process of performing a comparison of a second reading result by the reading device with the first reading result;
a process of changing the first printing condition to a second printing condition different from the first printing condition based on a comparison result; and
a process of reprinting the second code image on the print medium by causing the ejecting head to eject the liquid droplets based on the print data and the second printing condition after the process of changing.

8. A non-transitory medium storing a printing program executable by a computer in each of a first printing apparatus and a second printing apparatus, the first printing apparatus including a first ejecting head configured to eject liquid droplets to a print medium and a first reading device configured to read an image, the second printing apparatus including a second ejecting head configured to eject liquid droplets to a print medium and a second reading device configured to read an image, the program causing the computer to execute:
a step of determining a first printing condition for printing a code image on the print medium based on print data;
a step of printing a first code image corresponding to the code image on the print medium by causing the first ejecting head to eject the liquid droplets based on the print data and the first printing condition;
a step of causing the first reading device to read the first code image printed on the print medium;
a step of printing a second code image corresponding to the code image on the print medium by causing the second ejecting head to eject the liquid droplets based on the print data and the first printing condition;
a step of causing the second reading device to read the second code image printed on the print medium;
a step of performing a comparison of a second reading result by the second reading device with a first reading result by the first reading device;
a step of changing the first printing condition to a second printing condition different from the first printing condition based on a comparison result; and
a step of reprinting the second code image on the print medium by causing the second ejecting head to eject the liquid droplets based on the print data and the second printing condition after the step of changing.
